(19) United States
(12) Patent Application Publication
(10) Pub. No.: US 2003/0192576 A1
(43) Pub. Date: Oct. 16, 2003

(54) Cleaning facility for tubing systems of vehicles

(76) Inventor: Henry C. Chu, Orange, CA (US)

Correspondence Address: CHARLES E. BAXLEY, 5th Floor, 59 John Street, New York, NY, 10038, US

(21) Appl. No.: 10/119,394

(22) Filed: Apr. 11, 2002

(51) Int. Cl. B08B 9/00

(52) U.S. Cl. 134/95.2; 134/169 A

(57) ABSTRACT

A cleaning facility for cleaning tubings of vehicle includes an air tubing system coupled to actuate a pump, and two air valves and two fluid valves coupled to the vehicle. The pump is coupled to a cleaning fluid reservoir for pumping the cleaning fluid to clean the vehicle. An air switch valve and a fluid switch valve are coupled to the air tubing system for selectively switching off the air or fluid valves. The cleaning facility may be operated without specially trained persons and may prevent the fluid container from being over pressurized.

### BACKGROUND OF THE INVENTION

1. Field of the Invention

The present invention relates to a cleaning facility, and more particularly to a cleaning facility for cleaning tubings of vehicles.

2. Description of the Prior Art

Vehicles, boats, or airplanes may include various kinds of tubings therein, such as the lubrication tubings, the air conditioning tubings, the fuel supplying tubings, etc., which comprise a number of tubings that are required to be cleaned after a period of time of using.

Various kinds of typical cleaning facilities have been developed for cleaning the tubings or various systems of the vehicles, and comprise a fluid flowing system for filling fluid and detergent to clean the tubings of the vehicles. After the cleaning operation, an air flowing system is then provided for pumping air or for supplying pressurized air through the tubings of the vehicles in order to blow and to clean and to force the fluid and the detergent through the tubings of the vehicles into a fluid container. However, the pressurized air and the fluid and the detergent may all be forced and supplied into the fluid container, such that the fluid container may usually be over pressurized and may even be exploded after use. These problems annoy the vehicle cleaning operators much.

In addition, the fluid flowing system and the air flowing system of the typical cleaning facilities both include a number of couplers that are required to be coupled to and disengaged from the tubings of the vehicles alternatively and frequently, such that a lot of labor works are required for coupling and disconnecting the fluid flowing systems and the air flowing systems from the tubings of the vehicles, and such that the flushing and cleaning operations may not be done without the experienced and specially trained persons or experts.

The present invention has arisen to mitigate and/or obviate the afore-described disadvantages of the conventional cleaning facilities for cleaning the tubings of vehicles.

### SUMMARY OF THE INVENTION

The primary objective of the present invention is to provide a cleaning facility including a friendly operating arrangement for allowing the cleaning facility to be easily operated without experienced and specially trained persons or experts.

The other objective of the present invention is to provide a cleaning facility including an arrangement for preventing the fluid container from being over pressurized.

In accordance with one aspect of the invention, there is provided a cleaning facility for cleaning tubings of vehicle, the cleaning facility comprising a pump, an air tubing system coupled to the pump for supplying a pressurized air to actuate the pump, a first valve and a second valve for coupling to the vehicle, a reservoir coupled between the pump and the second valve, for receiving a cleaning fluid to clean the vehicle, and for allowing the pump to pump the cleaning fluid through the first valve and into the vehicle and then through the second valve and back to the reservoir, a third valve coupled between the air tubing system and the pump for selectively disabling the pump, a fourth valve and a fifth valve coupled to the air tubing system and for coupling to the vehicle, and for supplying the pressurized air through the vehicle, and means for selectively switching off the fourth and the fifth valves and switching on the first and the second valves, and for selectively switching on the fourth and the fifth valves and switching off the first and the second valves. The pressurized air from the air tubing system is allowed to flow through the fourth valve and into the vehicle and through the fifth valve and back to the reservoir. The cleaning facility may be operated without experienced and specially trained persons or experts, and includes an arrangement for preventing the fluid container from being over pressurized.

The selectively switching means includes a fluid switch valve switchable to close and to open the third valve, in order to actuate and to disable the pump.

The selectively switching means includes an air switch valve switchable to close the first and the second valves, in order to block a flowing passage for the fluid and detergent.

A sixth valve is further provided and coupled to the fourth valve for controlling the flowing of the pressurized air through the fourth valve. The air switch valve is switchable to close the sixth valve, in order to block a flowing passage for the pressurized air. The six valve is preferably a cylinder actuated valve.

A fluid filter is further provided and coupled between the reservoir and the second valve, for filtering the fluid and detergent before the fluid and detergent flowing into the reservoir.

An accumulator is further provided and coupled between the fifth valve and the reservoir, for collecting the pressurized air and the fluid and detergent. The accumulator includes an inlet, and a screen attached to the inlet of the accumulator for pacifying the pressurized air and the fluid and detergent.

The first and the second and the third and the fourth and the fifth valves are cylinder actuated valves. A vent is further provided and coupled to the reservoir for allowing the pressurized air to flow out of the reservoir via the vent.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a front perspective view of a housing of a cleaning facility for cleaning tubings of vehicles in accordance with the present invention;

FIG. 2 is a rear perspective view of the housing;

FIG. 3 is a diagram illustrating the complete tubing systems of the cleaning facility;

FIG. 4 is a diagram similar to FIG. 3, illustrating the flush and recycle tubing systems of the cleaning facility;

FIG. 5 is a diagram similar to FIGS. 3 and 4, illustrating the check and purge tubing systems of the cleaning facility;

FIG. 6 is a diagram similar to FIG. 5, illustrating the purge off operation of the cleaning facility;

FIG. 7 is a plane view illustrating a table of the control panel for the cleaning facility;

FIG. 8 is a partial perspective view illustrating a valve device for the cleaning facility; and

FIG. 9 is a cross sectional view taken along lines 9-9 of FIG. 8.

### DETAILED DESCRIPTION OF THE PREFERRED EMBODIMENT

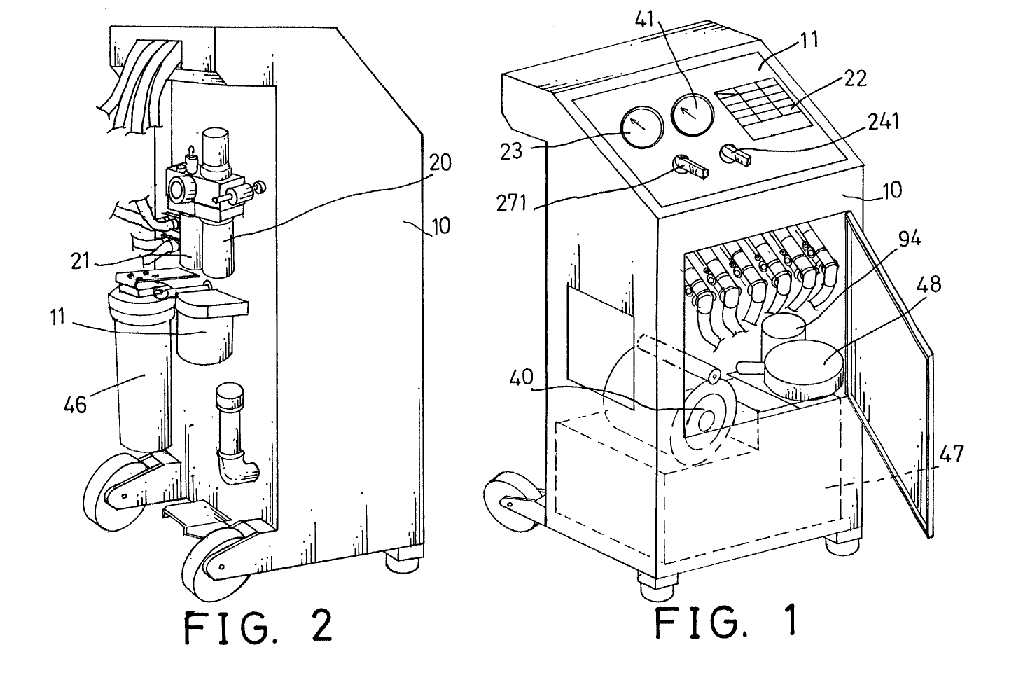

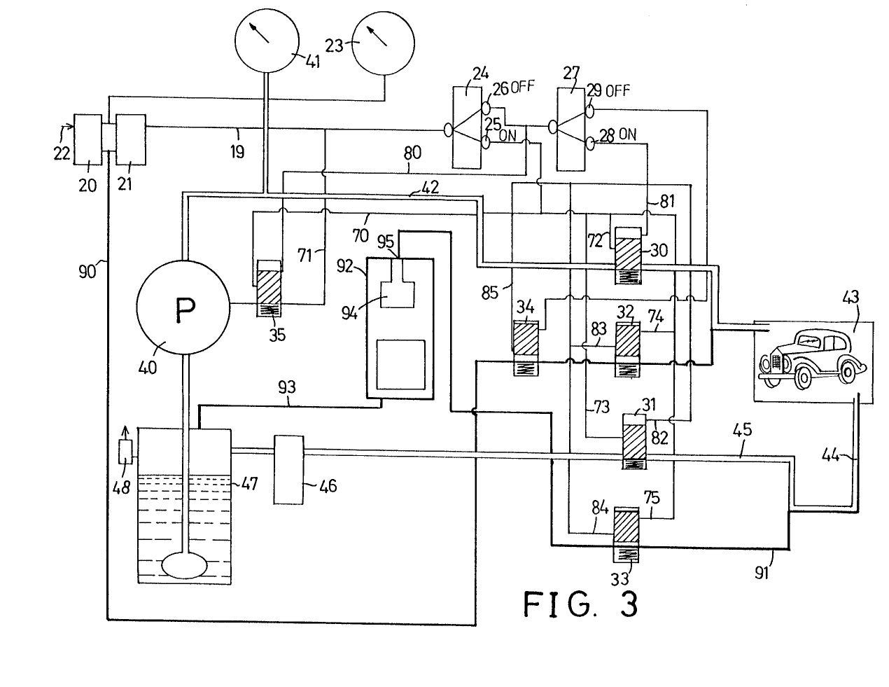

Referring to the drawings, and initially to FIGS. 1-3, a cleaning facility in accordance with the present invention is provided for cleaning various tubings of the vehicles, such as the lubrication tubings, the air conditioning tubings, the fuel supplying tubings, etc., and comprises a housing 10 having a control panel 11 provided on top thereof. FIG. 3 illustrates the complicated and complete tubing systems of the cleaning facility including both the air and the fluid flowing systems for flushing and recycling and purging purposes etc.

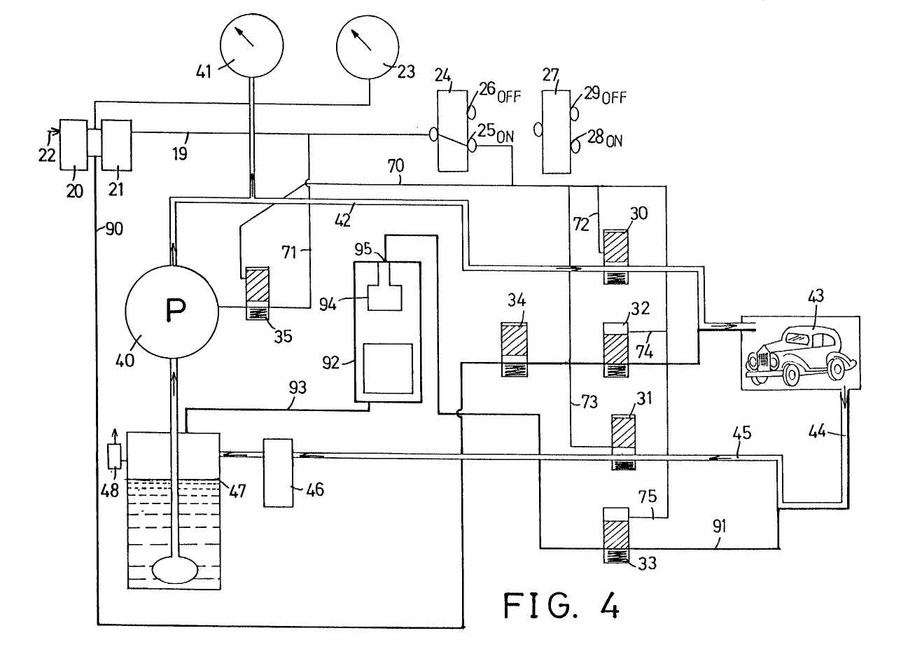

Referring next to FIGS. 4-6, and initially to FIG. 4, illustrated is the air and the fluid flowing systems for the flush and recycle operations of the cleaning facility. An air regulator or lubricator or filter 20 and an oiler 21 are provided and may be attached onto or into the housing 10 and coupled to an air tubing system 19. A shop air source or a pressurized air source 22 may be provided and coupled to the air filter 20 and the oiler 21 for allowing the pressurized air to flow into the air tubing system 19 after the pressurized air has been flown through the air filter 20 and the oiler 21 and has been filtered by the air filter 20. An air pressure gauge 23 is coupled to the air tubing system 19 for detecting and indicating the air pressure within the air tubing system 19.

The air tubing system 19 is then coupled to a switch valve, such as a 2-way, 3-way, or 4-way and two position manual and mechanical switch valve 24 which may be actuated or operated by a switch knob 241 (FIG. 1) and which may be used for controlling or switching the fluid flowing system on (25) and off (26); i.e., for switching on (25) or cutting off (26) the fluid flowing system. An air switch valve 27, such as a 4-way and two position manual and mechanical switch valve 27 which may be actuated or operated by a switch knob 271 (FIG. 1) and which may be used for controlling or switching the air flowing system on (28) and off (29); i.e., for switching on (28) or cutting off (29) the air flowing system. The operations of the air and fluid flowing systems will be described in further details hereinafter.

For example, as shown in FIG. 4, when the air switch valve 27 is switched to off (29) by the switch knob 271 (FIG. 1), and when the fluid switch valve 24 is switched to on (25) by the switch knob 241 (FIG. 1), the pressurized air in the air tubing system 19 may be supplied to open or to switch on an air valve 35 via a pipe 70. The pressurized air in the air tubing system 19 may be supplied through the air valve 35 and into a pump 40 via another pipe 71, and may also be supplied to open or to switch on two fluid valves 30, 32 via pipes 72, 73, and to close or to switch off two air valves 31, 33 via pipes 74, 75. The pressurized air supplied to the pump 40 via the air valve 35 may then be used to actuate or to operate the pump 40 which may be an air operated dual diaphragm pump, for example.

The pump 40 may then pump a cleaning fluid and/or detergent through a fluid hose 42. A fluid pressure gage 41 may be coupled to the fluid hose 42 for detecting and indicating the fluid pressure within the fluid hose 42. The fluid and detergent may then be supplied through the fluid valve 30 and into the tubings of the vehicle 43 in order to flush and to clean the tubings of the vehicle 43. After flushing the tubings of the vehicle 43, the fluid and detergent may flow through the hoses 44, 45 and the fluid valve 31 and a fluid filter 46 and then into a fluid reservoir 47, and may then be pumped through the hoses 42, 44, 45 and the fluid valves 30, 32 and the vehicle 43 again by the pump 40, in order to continuously flush and clean the tubings of the vehicles.

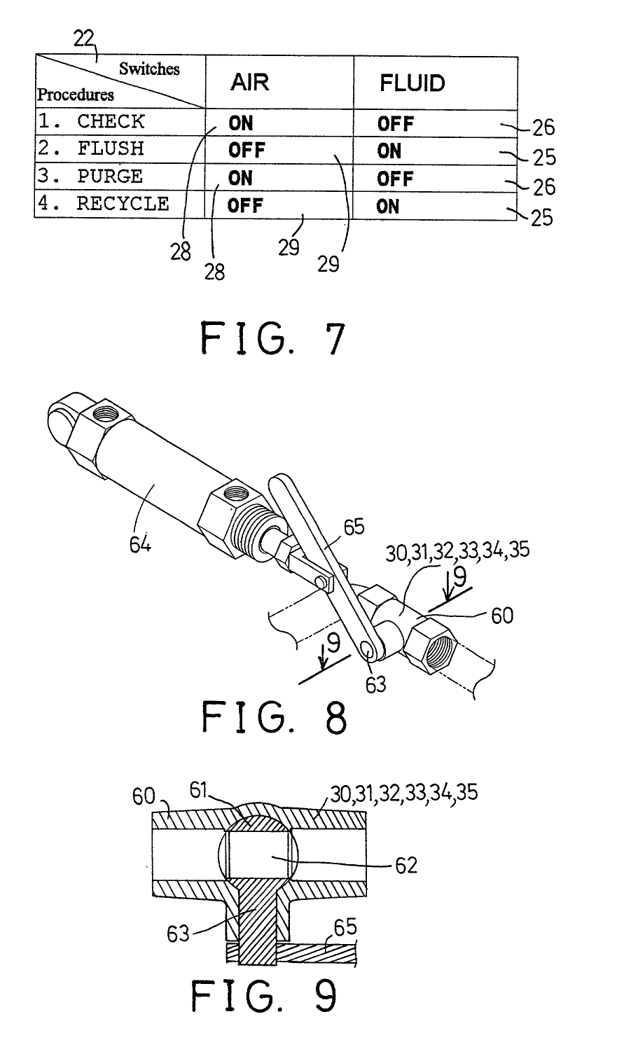

After the flushing operation to the vehicle, the couplers of the cleaning facility may be disengaged from the vehicle and the hoses 42, 44 may be coupled together to form a continuous fluid flowing passage. The air switch valve 27 may also be switched to off (29), and the fluid switch valve 24 may also be switched to on (25) in order to recycle the fluid and detergent (FIG. 7).

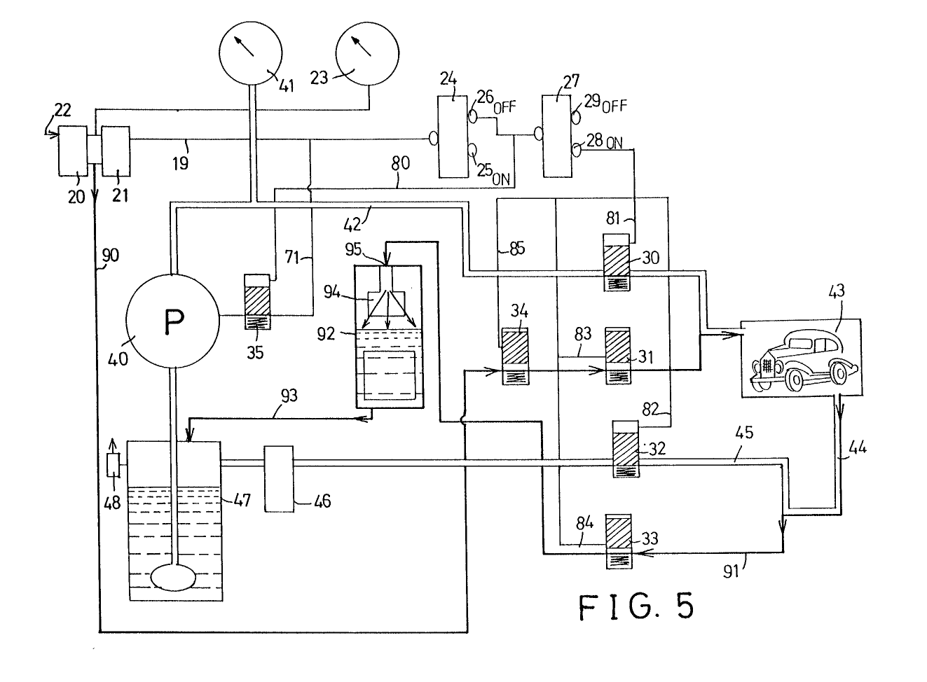

As shown in FIG. 5, when the fluid switch valve 24 is switched to off (26) and when the air switch valve 27 is switched to on (28), the pressurized air in the air tubing system 19 may be supplied to close or to switch off the air valve 35 via a pipe 80. The pressurized air from the pipe 71 may then be blocked by the air valve 35 such that the pump 40 may not be actuated, and such that the fluid and detergent may not be pumped and supplied through the fluid hoses 42, 44, 45 and the tubings of the vehicle 43. The pressurized air in the air tubing system 19 may also be supplied to close or to switch off the fluid valves 30, 32 via pipes 81, 82, and to open or to switch on the air valves 31, 33 via pipes 83, 84. Another air valve 34 is disposed in front of the air valve 31. The pressurized air may also be used to open or to switch on the air valve 34 via a pipe 85.

At this moment, the pressurized air flowing through the air filter 20 may flow through a pipe 90, and through the air valves 34, 31, and then may flow into the tubings of the vehicles 43, in order to blow and to clean or to dry the fluid and the detergent left in the tubings or pipes or hoses. The remains of the fluid and detergent may thus be blown and forced out of the vehicle 43 and be forced to flow through the hose 44 and a pipe 91 and then through the air valve 33 and then into an air muffler or a drier or an accumulator 92. The fluid valve 32 is blocked such that the pressurized air may not flow through the hose 45.

The air muffler or drier or an accumulator 92 may be used for collecting the fluid and detergent which may then be guided to flow into the reservoir 47 via a pipe 93. It is preferable that a filter or a muffler or a screen 94 may be attached to the inlet 95 of the accumulator 92, for pacifying the combination of the pressurized air and fluid and detergent. The air and the fluid and detergent may then be separated from each other within the reservoir 47, and the pressurized air may then flow out of the reservoir 47 via a vent or a check valve 48 or the like.

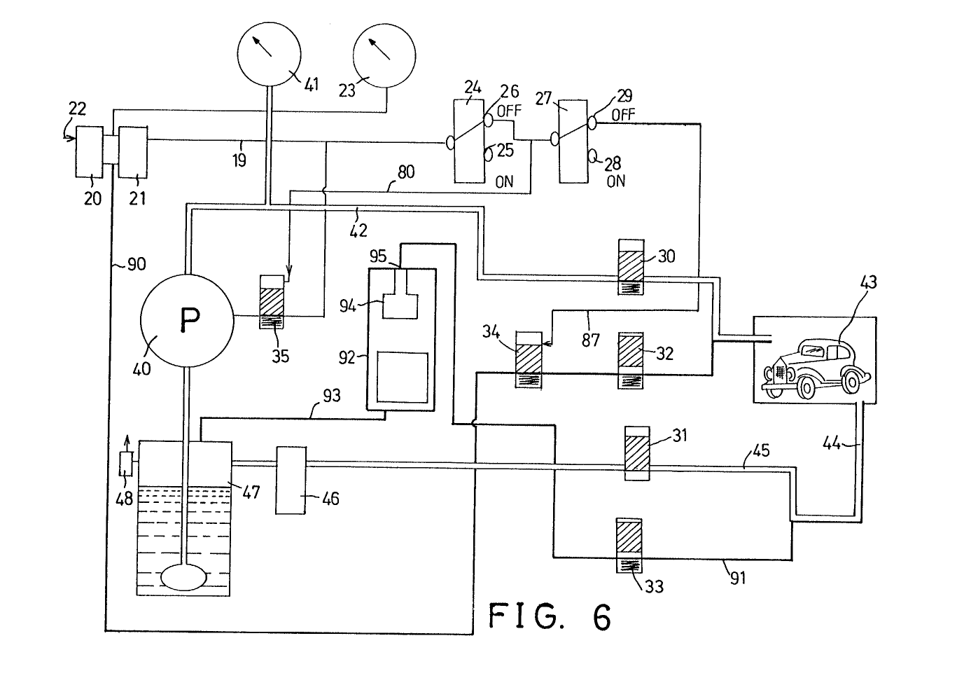

Referring next to FIG. 6, when both the fluid switch valve 24 and the air switch valve 27 are switched to off (26, 29), the air valve 35 will be closed or switched off, such that the pump 40 may not be actuated. The air valve 34 may also be closed or switched off by the air switch valve 27, such that the pressurized air from the pipe 90 may not flow through the air valve 34 and thus may not flow into the vehicle 43.

Referring next to FIGS. 8 and 9, the air valves 31, 33, 34 and the fluid valves 30, 32 may be various kinds of valves, but preferably be the cylinder actuated valves, each having a casing 60, a ball valve member 61 rotatably received in the casing 60 and having a duct 62 provided therein, and an arm 63 extended from the ball valve member 61 for coupling to a pneumatic or hydraulic cylinder 64 via a lever 65. The valves 30-34 may thus be operated or actuated with the pneumatic or hydraulic cylinder 64 that will not generate sparks.

It is to be noted that the vehicles cleaning and working environment may include various kinds of vaporizable and flammable oils or fuels or the like, and most of the detergents themselves are also flammable, such that the valves are preferably not the electric valves, such as the electromagnetic valves. However, if the electric valves may be suitably sealed or shielded, the cleaning facility may also be operated or actuated with the electric valves.

In the present cleaning facility, the pump 40 and the valves 30-35, and the air switch valve 27 and the fluid switch valve 24 may all be powered or actuated or operated with the shop air source or pressurized air source 22, such that no sparks will be generated, and such that the safety for operating the cleaning facility is greatly increased. In addition, the operators are only required to switch the air switch valve 27 and the fluid switch valve 24 on and off, such that the cleaning facility may be easily operated by any person without experienced and specially trained persons or experts. Furthermore, the air and the fluid and detergent may be collected and pacified and separated in the accumulator 92, and may then flow into the reservoir 47, and the pressurized air in the reservoir 47 may then flow out of the reservoir 47 via the vent 48, such that the reservoir 47 will not be over pressurized, and such that the reservoir 47 has no explosion problem.

Accordingly, the cleaning facility in accordance with the present invention includes a friendly operating arrangement for allowing the cleaning facility to be easily operated without experienced and specially trained persons or experts, and for preventing the fluid container from being over pressurized.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cleaning facility for cleaning tubings of vehicle, said cleaning facility comprising:
a pump,
an air tubing system coupled to said pump for supplying a pressurized air to actuate said pump,
a first valve and a second valve for coupling to the vehicle,
a reservoir coupled between said pump and said second valve, for receiving a cleaning fluid to clean the vehicle, and for allowing said pump to pump said cleaning fluid through said first valve and into the vehicle and then through said second valve and back to said reservoir,
a third valve coupled between said air tubing system and said pump for selectively disabling said pump,
a fourth valve and a fifth valve coupled to said air tubing system and for coupling to the vehicle, and for supplying the pressurized air through said vehicle, and
means for selectively switching off said fourth and said fifth valves and switching on said first and said second valves, and for selectively switching on said fourth and said fifth valves and switching off said first and said second valves,
the pressurized air from said air tubing system being allowed to flow through said fourth valve and into the vehicle and through said fifth valve and back to said reservoir.

2. The cleaning facility according to claim 1, wherein said selectively switching means includes a fluid switch valve switchable to close and to open said third valve, in order to actuate and to disable said pump.

3. The cleaning facility according to claim 1, wherein said selectively switching means includes an air switch valve switchable to close said first and said second valves, in order to block a flowing passage for the fluid and detergent.

4. The cleaning facility according to claim 1 further comprising a sixth valve coupled to said fourth valve for controlling the flowing of the pressurized air through said fourth valve.

5. The cleaning facility according to claim 4, wherein said selectively switching means includes an air switch valve switchable to close said sixth valve, in order to block a flowing passage for the pressurized air.

6. The cleaning facility according to claim 4, wherein said six valve is a cylinder actuated valve.

7. The cleaning facility according to claim 1 further comprising a fluid filter coupled between said reservoir and said second valve, for filtering the fluid and detergent before the fluid and detergent flowing into said reservoir.

8. The cleaning facility according to claim 1 further comprising an accumulator coupled between said fifth valve and said reservoir, for collecting the pressurized air and the fluid and detergent.

9. The cleaning facility according to claim 8, wherein said accumulator includes an inlet, and a screen attached to said inlet of said accumulator for pacifying the pressurized air and the fluid and detergent.

10. The cleaning facility according to claim 1, wherein said first and said second and said third and said fourth and said fifth valves are cylinder actuated valves.

11. The cleaning facility according to claim 1 further comprising a vent coupled to said reservoir for allowing the pressurized air to flow out of said reservoir via said vent.
